(19) United States
(12) Patent Application Publication
(10) Pub. No.: US 2004/0139357 A1
(43) Pub. Date: Jul. 15, 2004

(54) Electronic device having microcomputer and firmwave updating method thereof

(75) Inventor: Byung-Lae Lee, Suwon City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/689,038

(22) Filed: Oct. 21, 2003

(30) Foreign Application Priority Data
Jan. 14, 2003 (KR) 2003-2483

(51) Int. Cl. G06F 1/26

(52) U.S. Cl. 713/300

(57) ABSTRACT

An electronic device has a microcomputer and a firmware thereof, a power switching part generating an on/off handling signal according to an external handling, and a power supply part supplying power to the electronic device according to the on/off handling signal. An updating system controls a signal cut-off part cutting off (blocking) the on/off handling signal of the power switching part while the microcomputer firmware is being updated by the updating system. An update failure of the microcomputer firmware because of a handling error of the power switch is prevented, because the on/off handling signal is blocked during the firmware updating.

### CROSS-REFERENCE TO RELATED APPLICATIONS

This application claims the benefit of Korean Patent Application No. 2003-2483, filed Jan. 14, 2003, in the Korean Intellectual Property Office, the disclosure of which is incorporated herein by reference.

### BACKGROUND OF THE INVENTION

1. Field of the Invention

The present invention relates to an electronic device having a microcomputer and a firmware updating method thereof, and more particularly, to an electronic device having a microcomputer and a firmware updating method thereof preventing an update failure because of a handling error of a power switch during an update of a microcomputer firmware.

2. Description of the Related Art

Generally, a microcomputer for an overall control of a system, such as power control, is provided in an electronic device. A program, typically called a firmware, to perform a control algorithm is stored in an EEPROM or a flash memory included in the microcomputer.

The firmware stored in the microcomputer needs to be updated as necessary. Herein, the firmware can be updated by using a certain utility program reading an update code for a microcomputer firmware stored in an auxiliary device, such as an FDD, and writing the update code onto the microcomputer.

If a handling error of a power switch, for example, if a user pushes the power switch button by mistake, occurs during updating the microcomputer firmware, the updating fails and the existing microcomputer may have to be exchanged with another microcomputer storing a firmware in a normal condition, so that the exchanged microcomputer can be normally updated.

Various methods have been introduced to prevent an updating failure during updating the microcomputer firmware. However, when a firmware update error occurs, most of these methods focus only on retrieving a firmware in a normal condition, which is a former firmware condition without the error, by providing an extra memory storing the normal firmware before updating the firmware. Therefore, there is no method of blocking or preventing a cause of the error during the firmware updating.

### SUMMARY OF THE INVENTION

Accordingly, the present invention provides an electronic device having a microcomputer and a firmware updating method thereof preventing an update failure because of a handling error of a power switch (i.e., because of a power error/failure) during an update of the microcomputer firmware.

Additional aspects and advantages of the invention will be set forth in part in the description which follows and, in part, will be obvious from the description, or may be learned by practice of the invention.

The present invention may be achieved by providing an electronic device, comprising a power switching part generating an on/off handling signal according to an external handling, a power supply part supplying power to a system, a microcomputer storing a microcomputer firmware updateable by an updating system and controlling the power supply part based on the on/off handling signal of the power switching part, and a signal cut-off part cutting off the on/off handling signal of the power switching part from being transmitted to the microcomputer while the microcomputer firmware is being updated by the updating system.

According to an aspect of the present invention, the microcomputer generates a control signal when an update by the updating system is started and ended, and the signal cut-off part cuts off the on/off handling signal of the power switching part and releases the cut-off thereof based on the control signal.

According to an aspect of the present invention, the microcomputer generates a cut-off control signal when an update by the updating system is started and a release control signal when the update by the updating system is ended, and the signal cut-off part cuts off the on/off handling signal of the power switching part and releases the cut-off thereof based on the cut-off control signal and the release control signal.

According to an aspect of the present invention, the signal cut-off part comprises a tri-state buffer gate.

According to an aspect of the present invention, the signal cut-off part is provided between the power switching part and the microcomputer.

The present invention may also be achieved by providing a firmware updating method of an electronic device comprising generating an on/off handling signal according to an external handling of a power switching part; supplying power from a power supply part to a system of the electronic device, storing a microcomputer firmware updateable by an updating system; controlling the power supply part based on the on/off handling signal of the power switching part; activating a control signal when an update by the updating system is started; cutting off the on/off handling signal of the power switching part based on the activated control signal; inactivating the control signal when the update by the updating system is ended; and releasing the cut-off of the on/off handling signal of the power switching part based on the inactivated control signal.

According to an aspect of the present invention, the control signal is activated in the microcomputer by the updating system.

The present invention may also be achieved by providing a firmware updating method of an electronic device, comprising generating an on/off handling signal according to an external handling of a power switching part, supplying power from a power supply part to a system of the electronic device; storing a microcomputer firmware updateable by an updating system; controlling the power supply part based on the on/off handling signal of the power switching part; generating a cut-off control signal when an update by the updating system is started; cutting off the on/off handling signal of the power switching part based on the cut-off control signal; generating a release control signal when the update by the updating system is ended; and releasing the cut-off of the on/off handling signal of the power switching part based on the release control signal.

According to an aspect of the present invention, the cut-off control signal and the release control signal are generated in the microcomputer by the updating system.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a control block diagram of an electronic device with an updateable microcomputer firmware according to an embodiment of the present invention; and

FIG. 2 is a control flow diagram of updating the microcomputer firmware of the electronic device shown in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

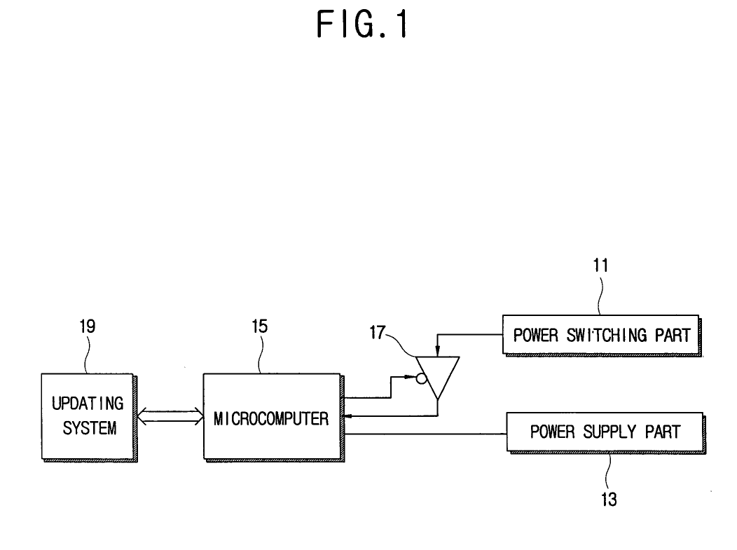

FIG. 1 is a control block diagram of an electronic device with an updateable microcomputer firmware, according to an embodiment of the present invention. As shown in FIG. 1, the electronic device comprises a power switching part 11 generating an on/off handling signal according to an external handling, a power supply part 13 supplying power to a system (i.e. the electronic device), and a microcomputer 15 controlling the power supply part 13 based on the on/off handling signal of the power switching part 11 and storing the microcomputer firmware updateable by an updating system 19.

The electronic device, further comprises a signal cut-off part 17, typically provided between the power switching part 11 and the microcomputer 15, and cutting off or transmitting the on/off handling signal of the power switching part 11 to the microcomputer 15 based on a control signal of the microcomputer 15. In particular, the microcomputer 15 cuts off or supplies power to the electronic device by controlling the power supply part 13 based on the on/off handling signal of the power switching part 11. The on/off handling signal of the power switching part 11 can be determined based on a state change by an external handling of the power switching part 11 or an on/off state of the system.

For example, if the on/off handling signal is changed from high to low while the system is on, the on/off handling signal can be recognized as an off signal. If the on/off handling signal is changed from low to high while the system is off, the on/off handling signal can be recognized as on. Typically, the on/off handling signal of the power switching part 11 is maintained high in a normal condition, so that the on/off handling signal becomes low if an external handling of the power switching part 11 occurs to engage the power switching part (for example, pushing a power button), and the on/off handling signal becomes high if an external handling of the power switching part 11 occurs to release the power switching part 11 (for example, releasing the power button).

Because, typically, the on/off handling signal of the power switching part 11 is a non-maskable interrupt signal, an action corresponding to the on/off handling signal must be performed, if the on/off handling signal of the power switching part 11 is input to the microcomputer 15. For example, in a conventional electronic device, if a user turns off the power switch by mistake during updating a microcomputer firmware, the microcomputer must cut off power to the system after receiving an off signal of the power switch even while the microcomputer firmware is being updated.

The updating system 19 comprises an updating application program to be loaded on an external controller (not shown) connected to the microcomputer 15, and controls an update of the microcomputer firmware. That is, the updating system 19 controls the update of the firmware in the microcomputer 15 by reading a code for a firmware to be changed (i.e., reading an updated firmware), which is stored in an external memory (not shown), and causing (controlling) the microcomputer 15 to output a predetermined control signal during the update of the firmware.

The control signal output by the microcomputer 15 may be one of a cut-off control signal cutting off the on/off handling signal of the power switching part 11 and a release control signal releasing the cut-off thereof. Especially, according to an aspect of the present invention, the cut-off control signal is generated when the update of the microcomputer firmware is started by the updating system 19, and the release control signal is generated when the update of the microcomputer firmware is ended by the updating system 19.

The signal cut-off part 17 is a circuit that cuts off or transmits the on/off handling signal of the power switching part 11 to the microcomputer 15, according to a control signal of the microcomputer 15. According to an aspect of the present invention, typically, the signal cut-off part 17 is a tri-state buffer gate, so that the signal cut-off part 17 can be in a high impedance state, in which the signal cut-off part 17 becomes an open circuit by receiving the microcomputer 15 control signal, and thus, an output thereof is cut off, as well as be in a high state and a low state according to the on/off handling signal of the power switching part 11.

For example, the signal cut-off part 17 can detect that the control signal of the microcomputer 15 is the release control signal, if maintained low, or changed from high to low, and control the on/off handling signal of the power switching part 11 to be normally transmitted to the microcomputer 15. Conversely, the signal cut-off part 17 can detect that the control signal of the microcomputer 15 is the cut-off control signal, if maintained high, or changed from low to high, and control the signal cut-off part 17 to be opened so that the on/off handling signal of the power switching part 11 cannot be transmitted to the microcomputer 15.

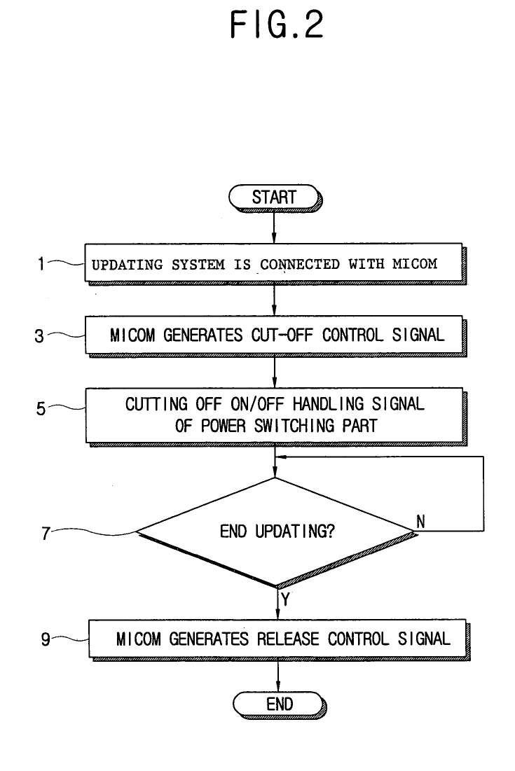

FIG. 2 is a control flow diagram of updating the microcomputer firmware of the electronic device shown in FIG. 2. As shown in FIG. 2, if, at operation 1, the updating system 19 is connected with the microcomputer 15 by being loaded onto an external controller connected to the microcomputer 15, at operation 3, the updating system 19 controls the microcomputer 15 to output a cut-off control signal (i.e., provide a power off block) to the signal cut-off part 17 before starting to update the microcomputer firmware. At operation 5, the signal cut-off part 17 receiving the cut-off control signal from the microcomputer 15, cuts off the on/off handling signal of the power switching part 11 from the microcomputer 15 by cutting off a connection between the power switching part 11 and the microcomputer 15.

At operation 7, while the microcomputer firmware is being updated by the updating system 19, the on/off handling signal of the power switching part 11 is blocked or not transmitted to the microcomputer 15. Thus, an update failure of the microcomputer firmware, which may be caused by cutting off power supply to the system during the update of the microcomputer firmware, is prevented. If the update of the microcomputer firmware is ended normally, at operation 9, the updating system 19 controls the microcomputer 15 to output a release control signal to the signal cut-off part 17. In particular, at operation 9, the signal cut-off part 17 connects together the power switching part 11 and the microcomputer 15, so that the on/off handling signal of the power switching part 11 is normally transmitted, or can be transmitted, to the microcomputer 15.

With the above configuration, the on/off handling signal of the power switching part 11 is cut off from the microcomputer 15 during updating of the microcomputer firmware, thereby preventing an update failure of the microcomputer firmware because of a handling error of a power switch. More particularly, the present invention provides an electronic device comprising a microcomputer with updateable firmware, a power switching part generating an on/off handling signal (on/off power control signal) according to an external handling of the power switching part, and a power supply part supplying power to the electronic device according to the on/off power control signal. An updating system updates the microcomputer and controls a signal cut-off part to cut off (block) the on/off power control signal of the power switching part while updating the microcomputer firmware. Therefore, an update failure of the microcomputer firmware because of a handling error of the power switch is prevented, because the on/off power control is blocked during the firmware updating. Accordingly, additional costs and time consumption accompanying an update failure of the microcomputer firmware can be removed.

Typically, the updating system 19 is software and/or computing hardware embodying the FIG. 2 processes. Although in the above-described embodiments, the updating system 19 controls the microcomputer 15 to output a control signal to the signal cut-off part 17 (i.e., output a power-off block signal blocking an on/off handling signal of the power switch 11), the present invention is not limited to such a configuration, and the microcomputer 15 may be configured/implemented to detect a firmware update state and to either output in the firmware update state the power-off block signal, or take blocking action in the firmware update state in response to an interrupt as an on/off handling signal of the power switch 11, or in response to device shutdown requests/functions, such as a power off, reset, or restart.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An electronic device having a power switching part generating an on/off handling signal according to an external handling of the power switching part, and a power supply part supplying power to a system of the electronic device, the electronic device comprising:
a microcomputer storing a microcomputer firmware updateable by an updating system and controlling the power supply part based on the on/off handling signal of the power switching part; and
a signal cut-off part cutting off the on/off handling signal of the power switching part from being transmitted to the microcomputer during the updating of the microcomputer firmware by the updating system.

2. The electronic device according to claim 1, wherein the microcomputer generates a control signal when an update by the updating system is started and ended, and the signal cut-off part cuts off the on/off handling signal of the power switching part and releases the cut-off thereof based on the control signal.

3. The electronic device according to claim 1, wherein the microcomputer generates a cut-off control signal when an update by the updating system is started and a release control signal when the update by the updating system is ended, and the signal cut-off part cuts off the on/off handling signal of the power switching part and releases the cut-off thereof based on the cut-off control signal and the release control signal.

4. The electronic device according to claim 2, wherein the signal cut-off part comprises a tri-state buffer gate.

5. The electronic device according to claim 3, wherein the signal cut-off part comprises a tri-state buffer gate.

6. The electronic device according to claim 1, wherein the signal cut-off part is provided between the power switching part and the microcomputer.

7. A firmware updating method of an electronic device having a power switching part generating an on/off handling signal according to an external handling of the power switching part, a power supply part supplying power to a system of the electronic device, and a microcomputer storing a microcomputer firmware updateable by an updating system and controlling the power supply part based on the on/off handling signal of the power switching part, the method comprising:
activating a control signal when an update by the updating system is started;
cutting off the on/off handling signal of the power switching part based on the activated control signal;
inactivating the activated control signal when the update by the updating system is ended; and
releasing the cut-off of the on/off handling signal of the power switching part based on the inactivated control signal.

8. The firmware updating method of an electronic device according to claim 7, wherein the control signal is activated in the microcomputer by the updating system.

9. A firmware updating method of an electronic device having a power switching part generating an on/off handling signal according to an external handling of the power switching part, a power supply part supplying power to a system of the electronic device, and a microcomputer storing a microcomputer firmware updateable by an updating system and controlling the power supply part based on the on/off handling signal of the power switching part, the method comprising:
generating a cut-off control signal when an update by the updating system is started;
cutting off the on/off handling signal of the power switching part based on the cut-off control signal;
generating a release control signal when the update by the updating system is ended; and
releasing the cut-off of the on/off handling signal of the power switching part based on the release control signal.

10. The firmware updating method of an electronic device according to claim 9, wherein the cut-off control signal and the release control signal are generated in the microcomputer by the updating system.

11. An electronic device, comprising:
a microcomputer with updateable firmware and configured to detect a firmware update state, and to block electronic device shutdown requests during the update state.

12. An electronic device, comprising:
a microcomputer with updateable firmware;
a power switching part generating an on/off power control signal controlling power supply to the electronic device; and
an updating system blocking the on/off power control signal during updating the microcomputer firmware.

13. The electronic device of claim 12, further comprising:
a signal cut-off part cutting off the on/off power control signal and wherein the updating system controls the microcomputer to output a control signal to the signal cut-off part to cut off the on/off power control signal during the microcomputer firmware updating.

14. The electronic device of claim 13, wherein the signal cut-off part is a tri-state buffer gate becoming an open circuit blocking transmission of the on/off power control signal to the microcomputer, according to the control signal from the microcomputer, and having a high state and a low state according to the on/off power control signal to the microcomputer to control power supply to the electronic device.

15. A microcomputer with an updateable firmware, comprising:
a blocker cutting off transmission of a power off signal to the microcomputer during updating of the firmware.
